(19) United States
(12) Patent Application Publication
(10) Pub. No.: US 2023/0368764 A1
(43) Pub. Date: Nov. 16, 2023

(54) ACOUSTIC LAMINATE

(71) Applicant: SEEDPOND PTY LTD, Balwyn North (AU)

(72) Inventor: Harvey Hui Xiong LAW, Balwyn North Victoria (AU)

(21) Appl. No.: 18/194,852

(22) Filed: Apr. 3, 2023

(30) Foreign Application Priority Data
Apr. 8, 2022 (AU) 2022900932

(51) Int. Cl. G10K 11/168; B32B 7/12; B32B 37/12

(52) U.S. Cl. CPC G10K 11/168; B32B 7/12; B32B 37/1207; B32B 2307/102; B32B 2307/7242; B32B 2037/1215; B32B 2307/72; B32B 2307/7376

(57) ABSTRACT

The present invention relates to a sound-absorbing laminate comprising a first flow resistive layer having a first air-flow resistance, a second flow resistive layer having a second air-flow resistance, and a first spacing layer located intermediate the first and second flow resistive layers. The present invention further comprises systems and structures comprising the laminate.

The present invention relates to a sound-absorbing laminate.

In one form, the invention relates to a laminate designed to absorb sound waves and dissipate energy directed towards the laminate.

In one particular aspect the present invention is suitable for use as a sound-absorbing structure, comprising multiple flow resistive layers to absorb sound waves and energy across a broad range of sound frequencies.

In another form, the invention relates to a system for absorbing sound comprising multiple layers, each layer having a predetermined air-flow resistance.

It will be convenient to hereinafter describe the invention in relation to ceiling tiles and acoustic lining for walls and ceiling however it should be appreciated that the present invention is not limited to those uses only.

### BACKGROUND ART

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Much of the noise heard in a room comprises direct sound from a source and reflected sound. Reflected sound bounces off the hard surfaces in the room, particularly the walls, floor, and ceiling. The reflected sound waves often collide. Reverberating sound and direct sound combine to create an acoustic jumble that can make communicating and listening extremely difficult.

To alleviate this problem, sound-absorbing materials are often attached to hard surfaces, or used to replace hard surfaces, in situations where the reduction of noise pollution is important. For example, sound absorbing tiles can be attached to walls, or hard ceilings can be replaced with sound absorbent panels. Sound absorption is measured in terms of the amount of energy removed from the sound wave as the wave passes through a given thickness of material.

Structures such as sound absorbent tiles and panels of the prior art are typically made of homogeneous media. Commonly used sound absorbing media include glass wool, rockwool, fibreglass, open-cell foams and polyester batts. Sound waves travel easily through homogeneous media. Some tiles and panels are configured according to various geometric shapes to channel sound waves into the sound absorbing media. The surface of the media has an open structure, typically an open cell structure in order to absorb the sound.

These open structures have the drawback of trapping particles or droplets of liquid that are always present in the atmosphere. Dust and droplets of oil or water are particularly problematic. Eventually, the sound absorbing materials lose their sound absorbing capacity when the particles or droplets clog the open cells on the surface of the sound absorbing media.

To protect these sound absorbent materials and prevent surface contamination by particles and droplets an impermeable membrane is often applied as a facing on the surface of the open cell structure. Typical facing materials include aluminium foil, mylar film and polyurethane film. These facing materials have poor acoustic properties and hinder noise from being absorbed by the underlying open cell material.

Furthermore, different sound frequencies require media having different sound absorption properties. Effective absorption of very high-frequency sound, for example above 2,000 Hz, requires a lightweight material with very open cells. Effective absorption of low-frequency sound requires a dense material with a semi-closed cell structure.

The human ear can sense soundwaves having a frequency between 16 Hz and about 16,000 Hz. Sound absorbing structures of the prior art tend to comprise a homogeneous material that absorbs sound at a frequency of around 50 Hz to 10,000 Hz in a “one-size fits all” approach.

U.S. Pat. No. 8,573,358 to Nonogi et al. relates to a multilayer sound absorbing structure that is extremely thin so that it can be used in electric and electronic equipment. The sound absorbing structure comprises a first microperforated film and a second microperforated film separated by a mesh layer.

The total thickness of Nonogi's structure may be about 50 to 150 microns, the thickness of the microperforated film being about 10 to 250 microns, and the thickness of the mesh being about 30 to 100 microns. The weight of the microperforated film is typically from about 5 g/m² to about 500 g/m². The weight of the mesh is typically 5 g/m² to 1500 g/m².

U.S. Pat. No. 8,277,596 to Zaveri et al. relates to a sound absorbing ceiling tile having a core of sound absorbing fibres covered with yarn that create a surface topography comprising peaks and troughs. A coating of contrasting colour is applied to various features of the topography. The ceiling tile combines high sound absorption and a rough surface texture.

U.S. Pat. No. 8,167,085 to Law relates to a non-combustible sound absorbing facing and a laminate comprising the facing and a substrate. The facing is preferably a non-combustible fabric and has an air-flow resistivity of between 80 and 3,000 MKS Rayls and a density of between 20 and 1,000 g/m².

U.S. Pat. No. 9,390,700 to Pham and Roberts relates to a laminate acoustic ceiling panel. The layers of the laminate are thick (for example 0.75 to 1 inch) and each have acoustic properties characterised, for example, by a noise reduction co-efficient (NRC) and ceiling attenuation class value (CAC). The invention is designed to increase the CAC of a ceiling tile that is to increase the blocking of sound between rooms having normal ceiling tiles.

### SUMMARY OF INVENTION

An object of the present invention is to provide a sound absorbing laminate having improved sound absorption.

Another object of the present invention is to provide a sound absorbing laminate having sound absorption across a broad range of frequencies.

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

In a first aspect of embodiments described herein there is provided a sound absorbing laminate consisting of multiple layers of air-flow resistant materials.

In another aspect of embodiments described herein there is provided a sound absorbing laminate comprising a first flow resistive layer having a first air-flow resistance, a second flow resistive layer, and a first spacing layer located intermediate the first and second flow resistive layers.

In contrast to laminate acoustic panels such as those described in U.S. Pat. No. 9,390,700, the first and second layers are very thin and are flow resistive. The layers do not have any acoustic properties by themselves, however the laminate has a sound absorption function when the spacing layer is located intermediate the first and second flow resistive layers.

In a preferred embodiment, the sound absorbing laminate comprises:
a first flow resistive layer, having a first air-flow resistance of 80 MKS Rayls to 4000 MKS Rayls;
a second flow resistive layer, having second air-flow resistance of 80 MKS Rayls to 4000 MKS Rayls, the second air-flow resistance being greater than the first air-flow resistance; and
a first spacing layer located intermediate the first flow resistive layer and the second flow resistive layer.

In another preferred embodiment, the sound absorbing laminate comprises:
a first flow resistive layer, having a first air-flow resistance of 80 MKS Rayls to 4000 MKS Rayls and a density of 80 g/m² to 500 g/m²;
a second flow resistive layer, having second air-flow resistance of 80 MKS Rayls to 4000 MKS Rayls, the second air-flow resistance being greater than the first air-flow resistance, and a density of 80 g/m² to 500 g/m²; and
a first spacing layer located intermediate the first flow resistive layer and the second flow resistive layer.

In yet another preferred embodiment, the sound absorbing laminate comprises:
a first flow resistive layer, having a first air-flow resistance of 80 MKS Rayls to 4000 MKS Rayls, a density of 80 g/m² to 400 g/m², and a thickness of 0.1 mm to 5 mm;
a second flow resistive layer, having second air-flow resistance of 80 MKS Rayls to 4000 MKS Rayls, the second air-flow resistance being greater than the first air-flow resistance, a density of 80 g/m² to 400/m², and a thickness of 0.1 mm to 5 mm; and
a first spacing layer having a thickness of 6 mm to 50 mm and located intermediate the first flow resistive layer and the second flow resistive layer.

Preferably, the first flow resistive layer has an air-flow resistance of 100 to 3000, 100 to 2000 or 100 to 1000 MKS Rayls. In a particularly preferred embodiment, the air-flow resistance is about 50 to 250 MKS Rayls.

Preferably, the second flow resistive layer has an air-flow resistance of 100 to 3000, 500 to 2000, or 750 to 1000 MKS Rayls. In a particularly preferred embodiment, the air-flow resistance is about 500 to 1000 MKS Rayls.

Preferably, the first flow resistive layer and/or the second flow resistive layer has a density of 100 to 300, or 150 to 500 g/m².

Preferably the first flow resistive layer and/or the second flow resistive layer has a thickness of 0.2 to 3, 0.3 to 2 or 0.4 to 1 mm.

A second spacing layer may be located adjacent the second flow resistive layer, parallel to the first spacing layer. Typically, in use, the second flow resistive layer is adjacent an air space, such as a wall or roof cavity.

In another embodiment of the invention, the second spacing layer comprises a material. Preferably the first spacing layer has a thickness of 5 to 40, 6 to 30, 7 to 20 or 8 to 10 mm. The thickness of the second spacing layer is 1.5 to 2.0 times the thickness of the first spacing layer. Preferably the second spacing layer has a thickness of 9 to 100, 7.5 to 80, 8 to 60, 10.5 to 40 or 12 to 20 mm.

Adjacent layers are typically bonded together by any convenient means known in the art. This includes for example, heat or adhesive bonding and spray application of adhesive. In a particularly preferred embodiment, the layers are bonded by a polyamide or a polyester hot melt adhesive. The adhesive is typically applied at a rate of 10 to 200 g/m², preferably 10 to 100 g/m². It is important that the adhesive is not applied in a quantity, or in a manner, that excessively blocks the voids in the layers.

In yet a further aspect of embodiments described herein there is provided a system for absorbing sound, the system comprising multiple flow resistive layers forming a stack having a depth, with adjacent layers separated by a spacing layer, wherein each layer has a predetermined air-flow resistance value, the value increasing across the depth of the stack.

By increasing the air flow resistance value from the front layer of the laminate (on which the sound wave initially impinges) to the rear layer, sound waves of decreasing frequency can be absorbed as they pass through the laminate. This provides sound absorption across a broad range of sound frequencies.

Using the laminate of the present invention, various frequencies of sound may be selectively absorbed. For example, the absorption coefficient of the laminate may be between 0.8 and 1.1 from 400 to 10,000 Hz, preferably between 0.6 and 1.1 from 400 to 10,000 Hz.

In another embodiment the absorption coefficient of the laminate may be greater than 0.4 from 400 to 1500 Hz, more preferably greater than 0.6 or greater than 0.8 from 400 to 900 Hz.

In yet a further aspect of embodiments described herein there is provided a method of reducing reflection of sound waves, the method comprising the step of positioning a laminate according to the present invention on a wall, ceiling, floor or hard surface.

In yet a further aspect of embodiments described herein there is provided a sound absorbing structure comprising a laminate according to the present invention. Typically, the sound absorbing structure is used for selectively absorbing sound frequencies to modify internal acoustics, reducing background noise and any echo effects.

The laminate of the present invention is useful for various sound absorbing structures, such as;
tiles for ceilings, walls or floors,
surface linings, such as for walls, ceilings, floors, room dividers or other hard surfaces, and
acoustic backing, such as for walls or ceilings.

Structures comprising the laminate can be attached to a wide range of surfaces and building structures such as, timber slats, metal slats, perforated panels, slotted panels, soffits and slabs.

The laminate of the present invention is useful for sound absorbing applications in a variety of locations, such as;
the interior of vehicles including buses, mining trucks, coaches, and train carriages,
the interior of buildings, including commercial offices, restaurants, and concert halls,
the interior of residences,
the interior of recording studios and other audio facilities, and
the interior of industrial sites such as factories, workshops and engineering facilities.

Other aspects and preferred forms are disclosed in the present specification and/or defined in the appended claims, forming a part of the description of the invention.

In essence, embodiments of the present invention stem from the realization that by having specific pre-defined air-flow resistance for each layer of a laminate arranged in successively increasing air-flow resistance from an outermost external layer to an innermost layer, a superior sound absorption can be achieved across a broad range of sound frequencies.

Advantages provided by the present invention comprise the following:
improved sound absorption, and/or
absorption of sound waves across a wide range of frequencies.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1A illustrates a cross-sectional plan view of one embodiment of a typical laminate according to the present invention.

FIG. 1B illustrates a cross-sectional plan view of a second embodiment of a typical laminate according to the present invention.

FIG. 2 illustrates graphs of absorption coefficient against frequency (Hz) illustrating the sound absorption properties for laminates according to the present invention. Each graph illustrates a group of laminates in which one or more of the air-flow resistance and/or thickness of the spacing layer has been varied.

FIG. 3 illustrates graphs of absorption coefficient against frequency (Hz) illustrating the sound absorption properties for laminates according to the present invention. Each graph illustrates a group of laminates in which one or more of the air-flow resistance and/or thickness of the spacing layer has been varied.

FIG. 4 illustrates graphs of absorption coefficient against frequency (Hz) illustrating the sound absorption properties for laminates according to the present invention. Each graph illustrates a group of laminates in which one or more of the air-flow resistance and/or thickness of the spacing layer has been varied.

FIG. 5 illustrates graphs of absorption coefficient against frequency (Hz) illustrating the sound absorption properties for laminates according to the present invention. Each graph illustrates a group of laminates in which one or more of the air-flow resistance and/or thickness of the spacing layer has been varied.

FIG. 6 illustrates graphs of absorption coefficient against frequency (Hz) illustrating the sound absorption properties for laminates according to the present invention. Each graph illustrates a group of laminates in which one or more of the air-flow resistance and/or thickness of the spacing layer has been varied.

FIG. 7 illustrates graphs of absorption coefficient against frequency (Hz) illustrating the sound absorption properties for laminates according to the present invention. Each graph illustrates a group of laminates in which one or more of the air-flow resistance and/or thickness of the spacing layer has been varied.

FIG. 8 illustrates graphs of absorption coefficient against frequency (Hz) illustrating the sound absorption properties for laminates according to the present invention. Each graph illustrates a group of laminates in which one or more of the air-flow resistance and/or thickness of the spacing layer has been varied.

FIG. 9 illustrates graphs of absorption coefficient against frequency (Hz) illustrating the sound absorption properties for laminates according to the present invention. Each graph illustrates a group of laminates in which one or more of the air-flow resistance and/or thickness of the spacing layer has been varied.

FIG. 10 illustrates graphs of absorption coefficient against frequency (Hz) illustrating the sound absorption properties for laminates according to the present invention. Each graph illustrates a group of laminates in which one or more of the air-flow resistance and/or thickness of the spacing layer has been varied.

FIG. 11 illustrates graphs of absorption coefficient against frequency (Hz) illustrating the sound absorption properties for laminates according to the present invention. Each graph illustrates a group of laminates in which one or more of the air-flow resistance and/or thickness of the spacing layer has been varied.

FIG. 12 illustrates graphs of absorption coefficient against frequency (Hz) illustrating the sound absorption properties for laminates according to the present invention. Each graph illustrates a group of laminates in which one or more of the air-flow resistance and/or thickness of the spacing layer has been varied.

### DETAILED DESCRIPTION

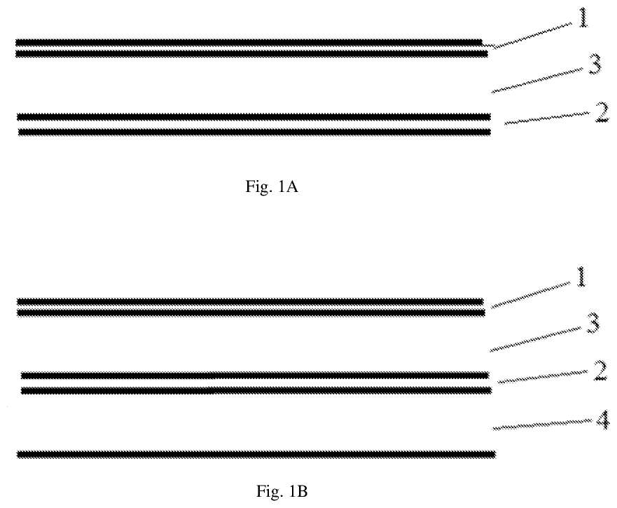

For purposes of description herein, the terms “upper,” “lower,” “right,” “left,” “rear,” “front,” “vertical,” “horizontal,” “interior,” “exterior,” and derivatives thereof shall relate to the invention as oriented in FIGS. 1A and 1B. However, it is to be understood that the invention may assume various alternative orientations, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Additionally, unless otherwise specified, it is to be understood that discussion of a particular feature of component extending in or along a given direction or the like does not mean that the feature or component follows a straight line or axis in such a direction or that it only extends in such direction or on such a plane without other directional components or deviations, unless otherwise specified.

This invention relates to a sound absorbing laminate with at least two air-flow resistive layers. In a given location, there will be a range of frequencies of sound and to address this, the laminate is designed to have layers of different acoustic impedance.

The externally positioned layer of the laminate on which incident soundwaves impinge has very low acoustic impedance relative to an internal layer so that the incident sound waves can enter the laminate with minimum reflection.

The internally positioned layer of the laminate that is further from the incident soundwaves has much higher acoustic impedance or higher density relative to the external or outwardly positioned layer. It is designed to further dissipate the sound waves once they have entered the system.

Where used herein, the term Rayl is a unit measure of specific acoustic impedance. Using the metre-kilogram-second system of units (MKS) 1 Rayl equals 1 pascal-second per meter (Pa·s·m⁻¹) or equivalently 1 newton-second per cubic meter (N·s·m⁻³).

FIG. 1A illustrates one embodiment of a typical laminate according to the present invention.

In this embodiment the first flow resistive layer (1) has a very low air-flow resistance of 80 MKS Rayls to 4000 MKS, preferably about 200 MKS Rayls, a density of 80 g/m² to 400 g/m², and a thickness of 0.1 mm to 4 mm. The first flow resistive layer (1) could, for example, be a membrane. This is the surface on which the sound wave first impinges.

The second flow resistive layer (2) has an air-flow resistance of 80 MKS Rayls to 4000 MKS Rayls, preferably about 800 MKS Rayls, a density of 80 g/m² to 400 g/m², and a thickness of 0.1 mm to 4 mm. The air-flow resistance of the second layer is greater than the air-flow resistance of the first layer.

The first and second flow resistive layers may be chosen from a range of materials including, but not limited to, woven fabric, woven glass fibre fabric, non-woven fabric, micro-perforated film, ceramic fabric, perforated or microperforated fabric and a micro-perforated metal foil such as aluminium foil, compressed polyester board, compressed glass fibre board.

Sandwiched between the first flow resistive layer (1) and second flow resistive layer (2) is a first spacing layer (3) having a thickness of 6 mm to 50 mm Typically, the first spacing layer (3) is either open-cell foams such as polyurethane foam, polyester batts, glass fibre, rockwool, melamine foam or polyamide foam, or any suitable combination thereof.

Typically, in use, there would be an air gap acting as a second spacing layer adjacent the second flow resistive layer (2). Preferably the thickness of the air gap is about 1.5 to 2 times the thickness of the first spacing layer (3).

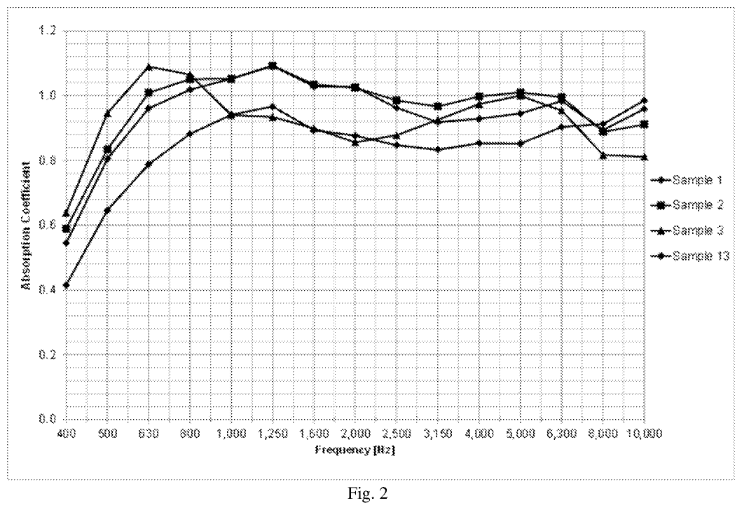

FIG. 1B illustrates a cross-sectional plan view of a second embodiment of a typical laminate according to the present invention. As shown in FIG. 2, a second spacing layer (4) may be provided by a layer of material such as open-cell polyurethane foam, polyester batts, glass fibre, rockwool and melamine foam.

In this embodiment, preferably the thickness of the second spacing layer (4) is about 1.5 to 2 times the thickness of the first spacing layer (3). Preferably the density of the second spacing layer (4) is 1.1 to 2 times the density of the first spacing layer (3).

Preferably the thickness of the assembled laminate is between 12 mm and 100 mm, 20 and 80 mm, or 25 and 60 mm.

In the embodiments disclosed in FIGS. 1A and 1B, adjacent layers are typically bonded together by any convenient means known in the art. This includes for example, heat or adhesive bonding and spray application of adhesive. In a particularly preferred embodiment, the layers are bonded by a polyamide or a polyester hot melt adhesive. The adhesive is typically applied at a rate of 10 to 200 g/m², preferably 10 to 100 g/m². It is important that the adhesive is not applied in a quantity, or in a manner, that excessively blocks the voids in the layers.

The invention will be further described with reference to the following non-limiting Examples.

### Example 1

This example compares laminates according to the present invention as shown in FIG. 1B. In this example, the air-flow resistance of the first and second flow resistive layers is varied while all other parameters remain unchanged.

The first and second flow resistive layers comprise a woven glass fibre/ceramic fabric, having a density of about 200 g/m², thickness of about 0.2 mm and various air-flow resistance as follows:
MR2.5: 80 MKS Rayls
MR5: 200 MKS Rayls
MR15: 800 MKS Rayls
MR45: 2000 MKS Rayls

The first and second spacing layer comprises melamine foam having a density of 8 kg/m³.

TABLE 1

| | First Flow | First | Second Flow | Second |
|---|---|---|---|---|
| | Resistive | Spacing | Resistive | Spacing |
| Sample | Layer | Layer | Layer | Layer |
| 1 | MR5 | 12 mm | MR15 | 12 mm |
| 2 | MR15 | 12 mm | MR5 | 12 mm |
| 3 | MR2.5 | 12 mm | MR45 | 12 mm |
| 4 | MR5 | 12 mm | MR2.5 | 12 mm |
| 5 | MR5 | 12 mm | MR15 | 12 mm |
| 6 | MR5 | 12 mm | MR45 | 12 mm |
| 7 | MR15 | 12 mm | MR2.5 | 12 mm |
| 8 | MR15 | 12 mm | MR5 | 12 mm |
| 9 | MR15 | 12 mm | MR45 | 12 mm |
| 10 | MR45 | 12 mm | MR2.5 | 12 mm |
| 11 | MR45 | 12 mm | MR5 | 12 mm |
| 12 | MR45 | 12 mm | MR15 | 12 mm |

| | |
|---|---|
| 13 | 24 mm Homogeneous Foam |

Sample 13 is a homogeneous foam sample, namely melamine foam, that has been included as the baseline reference.

The sound absorption coefficient measurements for groups of samples are depicted in FIG. 2 to FIG. 5. Measurements were conducted in an Alpha Cabin, which is a reduced-size reverberation room that provides fast and accurate sound absorption measurements in a diffuse-field condition. A relatively small sample size of only 1.2 m² is required in an Alpha Cabin, compared to a sample size of 10 m² to 12 m² required for a standard reverberation room.

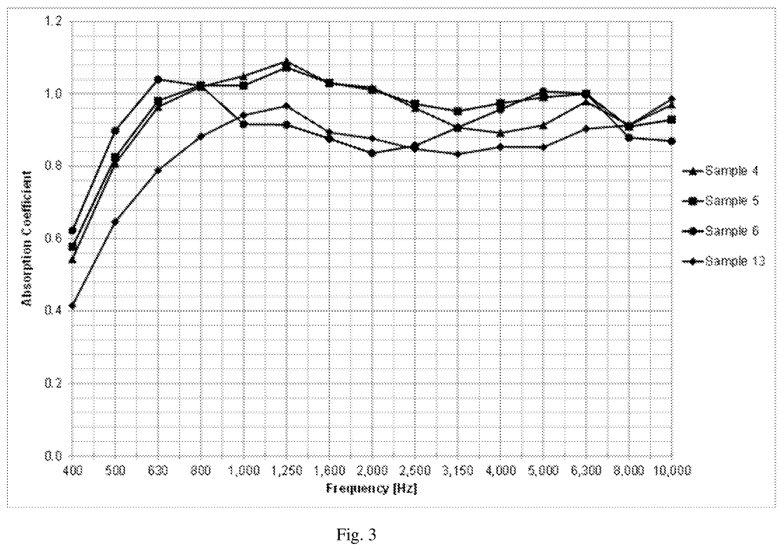

The laminate samples 1 to 6 shown in FIGS. 2 and 3 provide good absorption at all frequencies, particularly from 1,000 to 6,300 Hz.

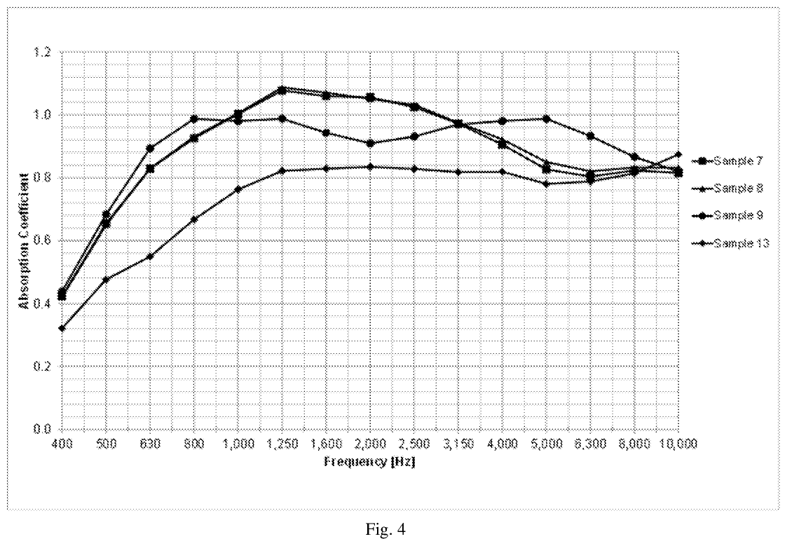

The samples 7 to 9 shown in FIG. 4 provides particularly good absorption for low to mid frequency sound absorption particularly from 1,000 to 2,500 Hz.

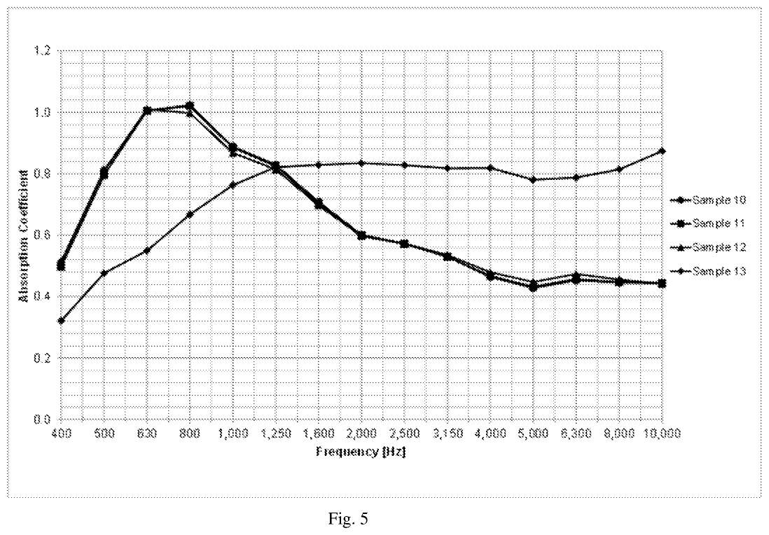

The samples 10 to 12 shown in FIG. 5 provide particularly good low-frequency sound absorption (about 500 Hz to 800 Hz, more particularly 500 Hz to 600 Hz) with a small amount of sound absorption at high frequencies (above 2,000 Hz).

### Example 2

In Example 2, the laminate structure is the same as Example 1, except that the thickness of the second spacing layer has been doubled.

TABLE 2

| | First Flow | First | Second Flow | Second |
|---|---|---|---|---|
| | Resistive | Spacing | Resistive | Spacing |
| Sample | Layer | Layer | Layer | Layer |
| 1 | MR5 | 12 mm | MR15 | 24 mm |
| 2 | MR15 | 12 mm | MR5 | 24 mm |
| 3 | MR2.5 | 12 mm | MR45 | 24 mm |
| 4 | MR5 | 12 mm | MR2.5 | 24 mm |
| 5 | MR5 | 12 mm | MR15 | 24 mm |
| 6 | MR5 | 12 mm | MR45 | 24 mm |
| 7 | MR15 | 12 mm | MR2.5 | 24 mm |
| 8 | MR15 | 12 mm | MR5 | 24 mm |
| 9 | MR15 | 12 mm | MR45 | 24 mm |
| 10 | MR45 | 12 mm | MR2.5 | 24 mm |
| 11 | MR45 | 12 mm | MR5 | 24 mm |
| 12 | MR45 | 12 mm | MR15 | 24 mm |

| | |
|---|---|
| 13 | 24 mm Homogeneous Foam |

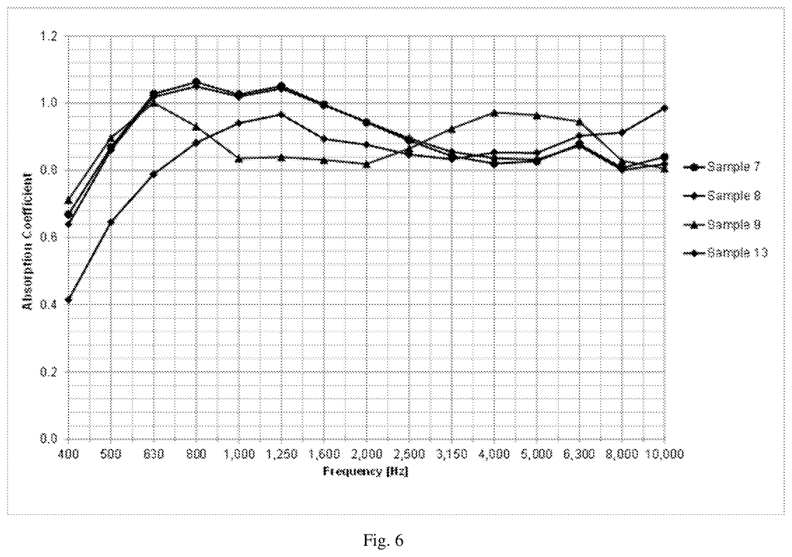

The sound absorption coefficient measurements (Alpha Cabin) for groups of samples are depicted in FIG. 6 to FIG. 9.

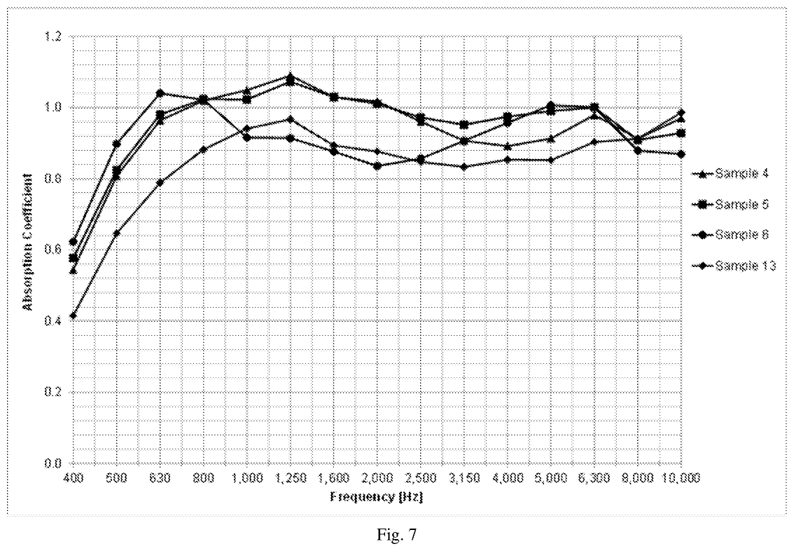

The samples 1 to 6 shown in FIG. 6 and FIG. 7 show good absorption (that is, an absorption coefficient of greater than about 0.4) at all frequencies. The absorption coefficient was better than about 0.6 or 0.8 from 600 to 10,000 Hz.

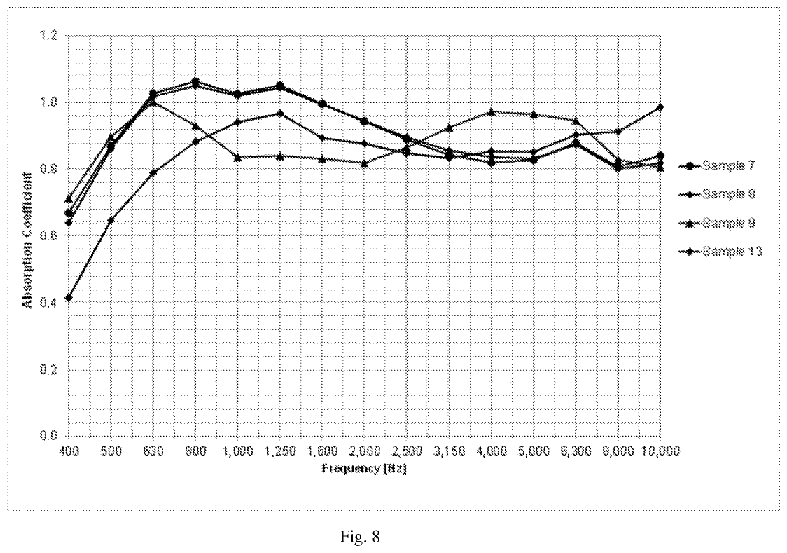

The samples 7 to 9 shown in FIG. 8 show good absorption in the low to mid-frequency range particularly 630 to 1,600 Hz.

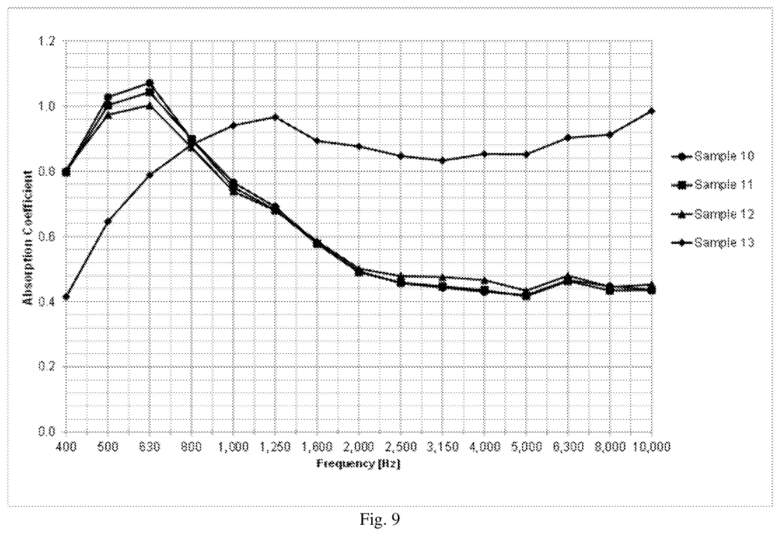

The samples 10 to 12 shown in FIG. 9 show good absorption for low-frequency sound (about 500 Hz to 600 Hz) with a small amount of sound absorption at high frequencies (above 2,000 Hz).

### Example 3

Example 3 compares laminates according to the present invention as shown in FIG. 1A.

This type of laminate would typically be used in applications that border a void, such as a ceiling or wall space. Typical applications of the laminate include ceiling grids to replace existing ceiling tiles, acoustic backing for timber battens, and acoustic backing for slotted or perforated boards.

In this example, the first air flow resistant layer has a density of 50 g/m² and thickness of 0.1 mm. The air-flow resistance was varied, as set out in Table 3.

The first spacing layer has a 12 mm thickness and density of 5 kg/m³.

The second air flow resistant layer has a thickness of 0.25 mm, a density of 200 g/m² and an air-flow resistance as set out in Table 3.

The second spacing layer is a 250 mm air-gap.

TABLE 3

| | First Flow | First | Second Flow | |
|---|---|---|---|---|
| Sam- | Resistive | Spacing | Resistive | Second Spacing |
| ple | Layer | Layer | Layer | Layer |
| 1 | MR5 | 12 mm | MR15 | 250 mm air-gap |
| 2 | MR15 | 12 mm | MR5 | 250 mm air-gap |
| 3 | MR2.5 | 12 mm | MR45 | 250 mm air-gap |
| 4 | MR5 | 12 mm | None | 250 mm air-gap |
| 5 | MR15 | 12 mm | None | 250 mm air-gap |
| 6 | none | 12 mm | MR5 | 250 mm air-gap |
| 7 | none | 12 mm | MR15 | 250 mm air-gap |

| | | |
|---|---|---|
| 8 | Commercial ceiling tile (USG Boral, 19 mm) | 250 mm air-gap |
| 9 | 12 mm Homogeneous foam | 250 mm air-gap |

Samples 4 and 5 have the second flow resistive layer removed.

Samples 6 and 7 have the first flow resistive layer removed.

Sample 8 is a commercially available ceiling tile, manufactured by USG Boral, and is 19 mm thick.

Sample 9 is a 12 mm thick homogeneous melamine foam

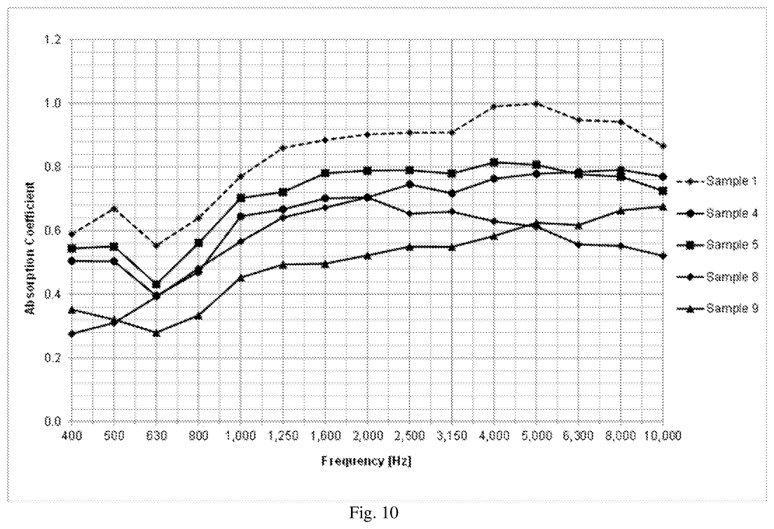

The sound absorption coefficient measurements (Alpha Cabin) for groups of samples are depicted in FIGS. 10 to 12.

FIG. 10 illustrates the improvement in sound absorption achieved when using two flow resistive layers, when compared to the 12 mm thick homogeneous foam, or laminates having only one flow resistive layer or the 19 mm thick commercially available ceiling tile.

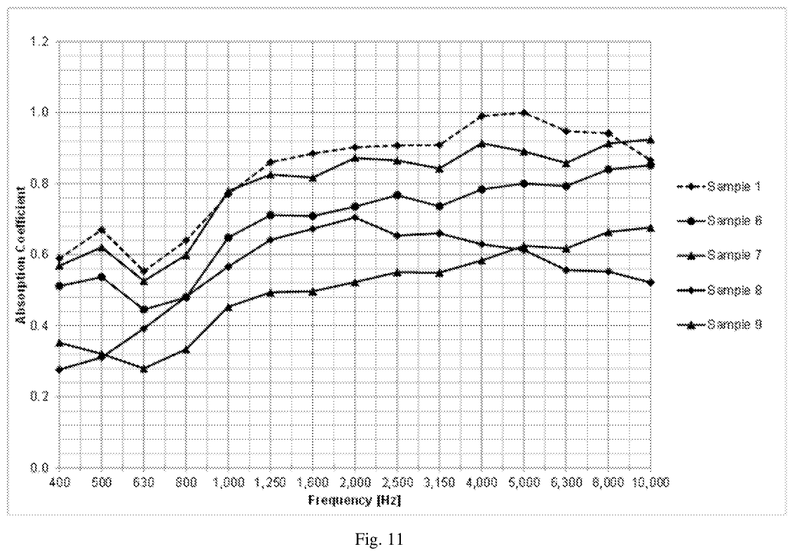

FIG. 11 illustrates the improvement in sound absorption achieved when using two flow resistive layers, in comparison to the 12 mm thick homogeneous foam, or laminates having only one flow resistive layer, or the 19 mm thick commercially available ceiling tile.

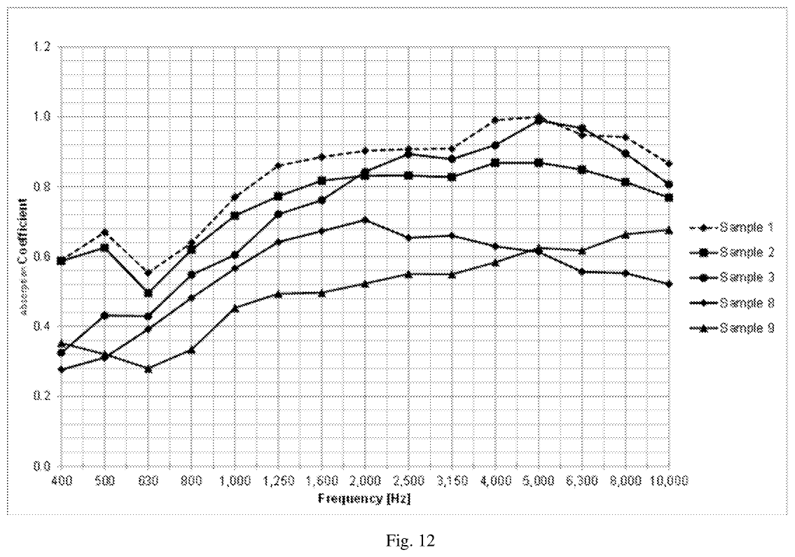

FIG. 12 shows the improvement in sound absorption achieved when using two flow resistive layers, compared to the 12 mm thick homogeneous foam and the 19 mm thick commercially available ceiling tile.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Whenever a range is given in the specification, all intermediate ranges and subranges, as well as all individual values included in the ranges given are intended to be included in the disclosure. It will be understood that any subranges or individual values in a range or subrange that are included in the description herein can be excluded from the claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. The broad term “comprising” is intended to encompass the narrower “consisting essentially of” and the even narrower “consisting of.” Thus, in any recitation herein of a phrase “comprising one or more claim element” (e.g., “comprising A), the phrase is intended to encompass the narrower, for example, “consisting essentially of A” and “consisting of A” Thus, the broader word “comprising” is intended to provide specific support in each use herein for either “consisting essentially of” or “consisting of.” The invention illustratively described herein suitably may be practiced in the absence of any element or elements, limitation or limitations which is not specifically disclosed herein.

One of ordinary skill in the art will appreciate that materials and methods, other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by examples, preferred embodiments and optional features, modification and variation of the concepts herein disclosed may be resorted to by those skilled in the art, and that such modifications and variations are considered to be within the scope of this invention as defined by the appended claims.

Each references cited herein is incorporated by reference herein in their entirety. Such references may provide sources of materials; alternative materials, details of methods, as well as additional uses of the invention.

1. A sound absorbing laminate comprising a first flow resistive layer having a first air-flow resistance, a second flow resistive layer having a second air-flow resistance, and a first spacing layer located intermediate the first and second flow resistive layers.

2. The sound absorbing laminate of claim 1 comprising:
a first flow resistive layer, having a first air-flow resistance of 80 MKS Rayls to 4000 MKS Rayls;
a second flow resistive layer, having second air-flow resistance of 80 MKS Rayls to 4000 MKS Rayls, the second air-flow resistance being greater than the first air-flow resistance; and
a first spacing layer located intermediate the first flow resistive layer and the second flow resistive layer.

3. The sound absorbing laminate of claim 1 comprising:
a first flow resistive layer, having a first air-flow resistance of 80 MKS Rayls to 4000 MKS Rayls and a density of 80 g/m² to 500 g/m²;
a second flow resistive layer, having second air-flow resistance of 80 MKS Rayls to 4000 MKS Rayls, the second air-flow resistance being greater than the first air-flow resistance, and a density of 80 g/m² to 500 g/m²; and
a first spacing layer located intermediate the first flow resistive layer and the second flow resistive layer.

4. The sound absorbing laminate of claim 1 comprising:
a first flow resistive layer, having a first air-flow resistance of 80 MKS Rayls to 4000 MKS Rayls, a density of 80 g/m² to 400 g/m², and a thickness of 0.1 mm to 5 mm;
a second flow resistive layer, having second air-flow resistance of 80 MKS Rayls to 4000 MKS Rayls, the second air-flow resistance being greater than the first air-flow resistance, a density of 80 g/m² to 400/m², and a thickness of 0.1 mm to 5 mm; and
a first spacing layer having a thickness of 6 mm to 50 mm and located intermediate the first flow resistive layer and the second flow resistive layer.

5. The sound absorbing laminate according to claim 1, further comprising a second spacing layer located adjacent the second flow resistive layer, parallel to the first spacing layer.

6. The sound absorbing laminate according to claim 1, wherein the first flow resistive layer is chosen from woven fabric, woven glass fibre fabric, non-woven fabric, micro-perforated film, ceramic fabric, perforated or microperforated fabric and a micro-perforated metal foil.

7. The sound absorbing laminate according to claim 1, wherein the second flow resistive layer is chosen from woven fabric, woven glass fibre fabric, non-woven fabric, micro-perforated film, ceramic fabric, perforated or microperforated fabric and a micro-perforated metal foil.

8. The sound absorbing laminate according to claim 1, wherein adjacent layers are bonded by a hot melt adhesive chosen from polyamide or polyester and applied to the layers at a rate of 10 to 400 g/m².

9. A system for absorbing sound, the system comprising multiple flow resistive layers forming a stack having a depth, with adjacent layers separated by a spacing layer, wherein each layer has a predetermined air-flow resistance value, the value increasing across the depth of the stack.

10. The system according to claim 9, comprising the laminate.

11. The system according to claim 10, wherein the air flow resistance value increases from the flow resistive layer of the laminate on which a sound wave initially impinges, to the rearmost layer of the laminate.

12. The system according to claim 10, wherein the absorption coefficient of the laminate is between 0.8 and 1.1 for sound waves of frequency from 400 to 1500 Hz.

13. A method of reducing reflection of sound waves, the method comprising the step of positioning a laminate according to claim 1 on a wall, ceiling, floor or hard surface.

14. A sound absorbing structure comprising a laminate according to claim 1.
